(19) United States
(12) Patent Application Publication
(10) Pub. No.: US 2020/0227004 A1
(43) Pub. Date: Jul. 16, 2020

(54) METHOD FOR REDUCING POWER CONSUMPTION OF DISPLAY PANEL AND DISPLAY DEVICE WITH LOW POWER CONSUMPTION

(71) Applicant: Wuhan China Star Optoelectronics Technology Co., Ltd., Wuhan (CN)

(72) Inventors: Qingcheng ZUO, Wuhan (CN); Xiaoling YUAN, Wuhan (CN)

(21) Appl. No.: 16/603,240

(22) PCT Filed: Apr. 29, 2019
(86) PCT No.: PCT/CN2019/084895

§ 371 Date: Oct. 7, 2019

(30) Foreign Application Priority Data
Aug. 28, 2018 (CN) 201810991148.4

(51) Int. Cl. G09G 5/10; G09G 5/00

(52) U.S. Cl. CPC G09G 5/10; G09G 5/003; G09G 2330/021; G09G 2340/0407; G09G 2360/144; G09G 2320/0626

(57) ABSTRACT

A method for reducing power consumption of a display panel includes steps of measuring a distance from a user's eyes to the display panel by an infrared sensing unit, and measuring an ambient light brightness by an ambient light sensing unit; transmitting the measured distance to a processing control unit by the infrared sensing unit, and transmitting the measured ambient light brightness to the processing control unit by the ambient light sensing unit; and adjusting a resolution of the display panel by the processing control unit based upon the measured distance and the measured ambient light brightness.

### FIELD OF INVENTION

The present disclosure relates to a technical field in display, and particularly to a method for reducing power consumption of a display panel and a device having a display panel with low power consumption.

### BACKGROUND OF DISCLOSURE

Currently, a backlight light emitting diode (LED) portion is the most power-consuming part in display modules of portable devices, such as mobile phones and tablets. Moreover, the trend of light and thin mobile phones and tablets extremely limits development of battery size and capacity. In order to solve the limitation of the battery capacity and reduce power consumption, content adaptive brightness control (CABC) technology and light adaptive brightness control (LABC) technology have been developed. The so-called LABC technology is a control technology that mainly adjusts backlight brightness of a portable device 2 by sensing ambient light brightness, as shown in FIG. 1. However, when a distance from the eyes to the display panel changes, information from the display panel perceived by the eyes will change. Especially, when the ambient light and the distance increase, the information perceived by the eyes will be significantly reduced. Currently, it is possible to compensate for the problem by simply adjusting the backlight brightness, but it causes a significant increase in power consumption (the backlight power consumption accounts for more than 80% of power consumption of small and medium-sized liquid crystal display panels). The method for ensuring the visual effect of the display panels while reducing the backlight power consumption is a subject worth studying.

### SUMMARY OF INVENTION

### Technical Problem

It is an object of the present disclosure to provide a method for reducing power consumption of a display panel, and a device having a display panel with low power consumption, which ensure the visual effect of the display panel while reducing backlight power consumption.

### Technical Solution

To solve the above technical problem, the present disclosure provides a method for reducing power consumption of a display panel, including:

a step 100 of measuring a distance from a user's eyes to the display panel by an infrared sensing unit, and measuring an ambient light brightness by an ambient light sensing unit;

a step 200 of transmitting the measured distance to a processing control unit by the infrared sensing unit, and transmitting the measured ambient light brightness to the processing control unit by the ambient light sensing unit; and

a step 300 of adjusting a resolution of the display panel by the processing control unit based upon the measured distance and the measured ambient light brightness.

In accordance with a feature of an embodiment of the present disclosure, the method further includes:

a step 400 of adjusting a brightness of the display panel by the processing control unit based upon the measured distance and the measured ambient light brightness.

In accordance with a feature of an embodiment of the present disclosure, the resolution of the display panel decreases when the measured distance increases, and the resolution of the display panel increases when the measured distance decreases.

In accordance with a feature of an embodiment of the present disclosure, the resolution of the display panel decreases when the measured ambient light brightness increases, and the resolution of the display panel increases when the measured ambient light brightness decreases.

In accordance with a further feature of an embodiment of the present disclosure, the brightness of the display panel increases when the measured ambient light brightness increases, and the brightness of the display panel decreases when the measured ambient light brightness decreases.

In accordance with a further feature of an embodiment of the present disclosure, the brightness of the display panel increases when the measured distance increases, and the brightness of the display panel decreases when the measured distance decreases.

In accordance with a feature of an embodiment of the present disclosure, the step 200 includes:

a step of converting the measured distance into a distance coefficient and transmitting the distance coefficient to the processing control unit by the infrared sensing unit, and a step of converting the measured ambient light brightness into an ambient light coefficient and transmitting the ambient light coefficient to the processing control unit by the ambient light sensing unit; and

the step 300 includes:

a step of adjusting the resolution of the display panel by the processing control unit based upon the distance coefficient and the ambient light coefficient.

In accordance with a feature of an embodiment of the present disclosure, the step 300 includes:

a step of converting the measured distance into a distance coefficient by the processing control unit, a step of converting the measured ambient light brightness into an ambient light coefficient by the processing control unit, and a step of adjusting the resolution of the display panel by the processing control unit based upon the distance coefficient and the ambient light coefficient.

The present disclosure also provides a device having a display panel with low power consumption, including:

an infrared sensing unit including an infrared sensor, configured for measuring a distance from a user's eyes to the display panel, and transmitting the measured distance to a processing control unit;

an ambient light sensing unit including an ambient light sensor, configured for measuring an ambient light brightness, and transmitting the measured ambient light brightness to the processing control unit; and

the processing control unit including a processor, and configured for adjusting a resolution of the display panel based upon the measured distance and the measured ambient light brightness.

In accordance with a feature of an embodiment of the present disclosure, the processing control unit configured for adjusting a brightness of the display panel based upon the measured distance and the measured ambient light brightness.

In accordance with a feature of an embodiment of the present disclosure, the processing control unit is configured for lowering the resolution of the display panel in response to the measured distance being greater than a threshold, and the processing control unit is configured for raising the resolution of the display panel in response to the measured distance being smaller than another threshold.

In accordance with a feature of an embodiment of the present disclosure, the processing control unit is configured for lowering the resolution of the display panel in response to the measured ambient light brightness being greater than a threshold, and the processing control unit is configured for raising the resolution of the display panel in response to the measured ambient light brightness being smaller than another threshold.

In accordance with a further feature of an embodiment of the present disclosure, the processing control unit is configured for raising the brightness of the display panel in response to the measured ambient light brightness being greater than a threshold, and the processing control unit is configured for lowing the brightness of the display panel in response to the measured ambient light brightness being smaller than another threshold.

In accordance with a further feature of an embodiment of the present disclosure, the processing control unit is configured for raising the brightness of the display panel in response to the measured distance being greater than a threshold, and the processing control unit is configured for lowing the brightness of the display panel in response to the measured distance being smaller than another threshold.

In accordance with a feature of an embodiment of the present disclosure, the infrared sensing unit is further configured for converting the measured distance into a distance coefficient, and transmitting the distance coefficient to the processing control unit,

the ambient light sensing unit is further configured for converting the measured ambient light brightness into an ambient light coefficient, and transmitting the ambient light coefficient to the processing control unit; and

the processing control unit is further configured for adjusting the resolution of the display panel based upon the distance coefficient and the ambient light coefficient.

In accordance with a feature of an embodiment of the present disclosure, the processing control unit is configured for converting the measured distance into a distance coefficient, converting the measured ambient light brightness into an ambient light coefficient, and adjusting the resolution of the display panel based upon the distance coefficient and the ambient light coefficient.

### Beneficial Effect

In the method for reducing power consumption of the display panel, and the device having the display panel with low power consumption in the present disclosure, the infrared sensing unit measures the distance from the user's eyes to the display panel. When the measured distance increases, information perceived by the eyes (e.g., the perceived resolution) is reduced, and the processing control unit lowers the resolution of the display panel. When the measured distance decreases, the information perceived by the eyes (e.g., the perceived resolution) is increased, and the processing control unit raises the resolution of the display panel, thereby ensuring the visual effect of the display panel while reducing backlight power consumption.

### BRIEF DESCRIPTION OF DRAWINGS

FIG. 1 is a schematic diagram illustrating a display device in a conventional method, which adjusts corresponding backlight brightness by sensing the ambient light brightness, which is so-called light adaptive brightness control (LABC).

FIG. 2 is a schematic diagram illustrating a device having a display panel with low power consumption, which adjusts resolution of the display panel by measuring a distance from a user's eyes to the display panel in accordance with an embodiment of the present disclosure.

FIG. 3 is a flowchart illustrating steps of a method for reducing power consumption of a display panel in accordance with an embodiment of the present disclosure.

FIG. 4 is a schematic block diagram illustrating a display device with low power consumption in accordance with an embodiment of the present disclosure.

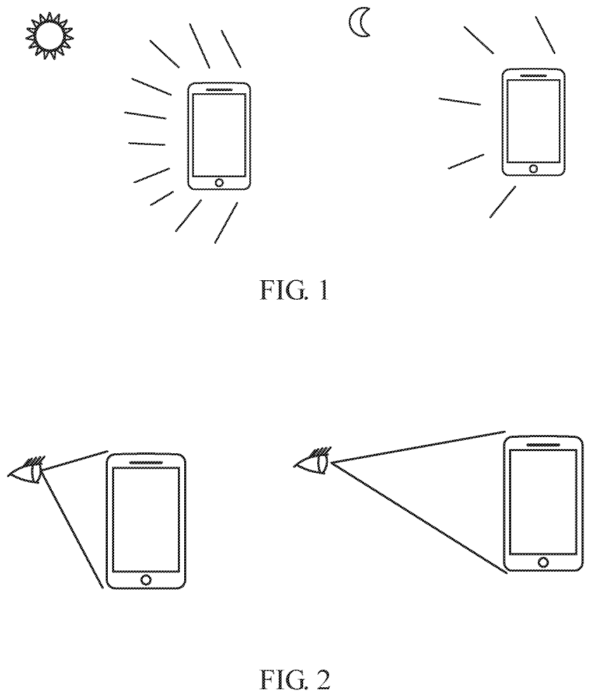

### DETAILED DESCRIPTION OF PREFERRED EMBODIMENTS

The following description of the embodiments with reference to the accompanying drawings is used to illustrate particular embodiments of the present disclosure. The directional terms referred in the present disclosure, such as “upper”, “lower”, “front”, “back”, “left”, “right”, “inner”, “outer”, “side surface”, etc. are only directions with regard to the accompanying drawings. Therefore, the directional terms used for describing and illustrating the present disclosure are not intended to limit the present disclosure. In the drawings, units with similar structures are indicated by the same reference number.

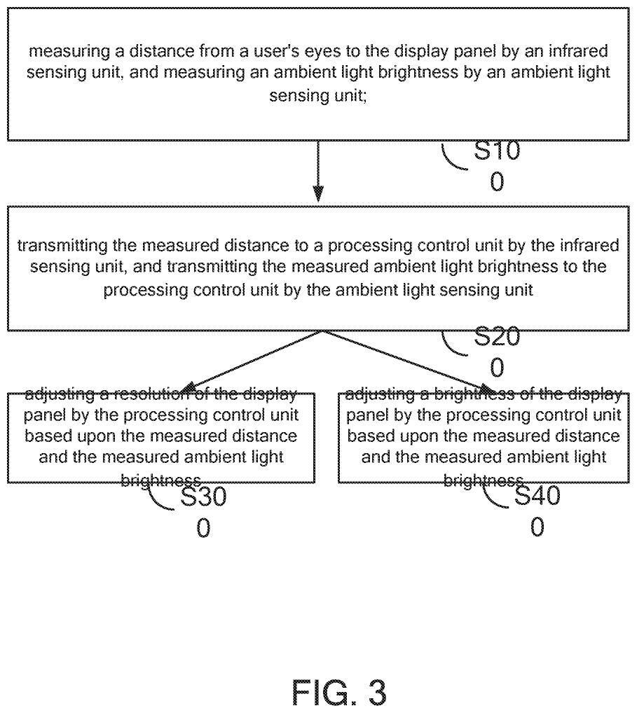

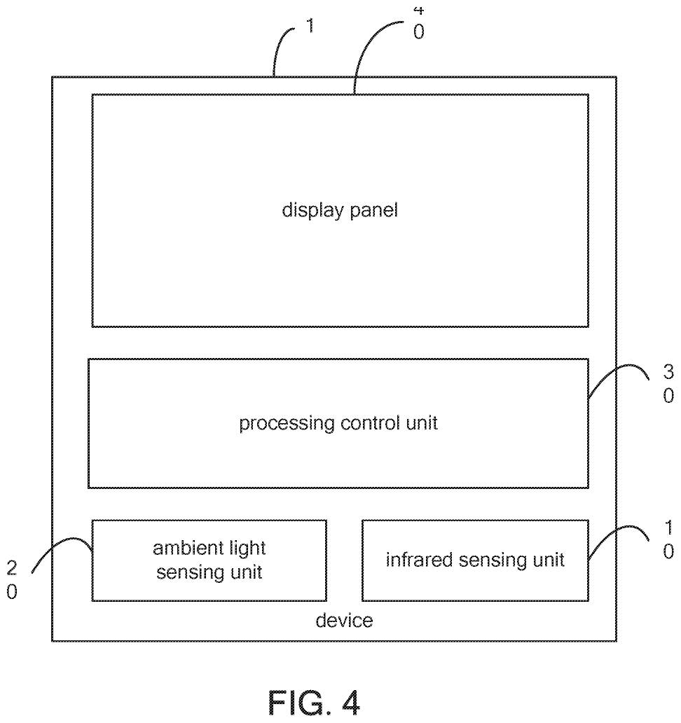

Refer to FIG. 2 and FIG. 3. FIG. 2 is a schematic diagram illustrating a device 1 having a display panel 40 with low power consumption, which adjusts resolution of the display panel 40 by measuring a distance from a user's eyes to the display panel 40, in accordance with an embodiment of the present disclosure. FIG. 3 is a flowchart illustrating steps of a method for reducing power consumption of the display panel 40 in accordance with an embodiment of the present disclosure.

The present disclosure provides a method for reducing power consumption of the display panel. The method includes the following steps:

A step 100 of measuring a distance from a user's eyes to the display panel 40 by an infrared sensing unit 10, and measuring an ambient light brightness by an ambient light sensing unit 20;

A step 200 of transmitting the measured distance to a processing control unit 30 by the infrared sensing unit 10, and transmitting the measured ambient light brightness to the processing control unit 30 by the ambient light sensing unit 20; and

A step 300 of adjusting a resolution of the display panel 40 by the processing control unit 30 based upon the measured distance and the measured ambient light brightness.

In accordance with an embodiment of the present disclosure, the method further includes a step 400 of adjusting a brightness of the display panel 40 by the processing control unit 30 based upon the measured distance and the measured ambient light brightness.

In accordance with a feature of an embodiment of the present disclosure, the step 200 includes a step of converting the measured distance into a distance coefficient transmitting the distance coefficient to the processing control unit 30 by the infrared sensing unit 10, and a step of converting the measured ambient light brightness into an ambient light coefficient and transmitting the ambient light coefficient to the processing control unit 30 by the ambient light sensing unit 20. Moreover, the step 300 includes a step of adjusting the brightness of the display panel 40 and the resolution of the display panel 40 by the processing control unit 30 based upon the distance coefficient and the ambient light coefficient.

In accordance with another embodiment of the present disclosure, the step 300 includes a step of converting the measured distance into a distance coefficient by the processing control unit 30, a step of converting the measured ambient light brightness into an ambient light coefficient by the processing control unit, and a step of adjusting the resolution of the display panel 40 by the processing control unit 30 based upon the distance coefficient and the ambient light coefficient.

For example, the distance coefficient ranges from 0 to 1. When the distance is 40 cm, the distance coefficient is 0.8. When the distance is nearly 10 cm, the distance coefficient is 0.2. However, the distances and the distance coefficients are only examples, and should not limit the scope of the present disclosure.

For example, the ambient light coefficient ranges from 0 to 1. In an outdoor environment, for example, when the illuminance is 30,000 lux, the ambient light coefficient is 0.9. In an indoor environment, for example, when the illuminance is 800 lux, the ambient light coefficient is 0.2. However, the ambient light brightnesses and the ambient light coefficients are only examples, and should not limit the scope of the present disclosure.

In accordance with a feature of an embodiment of the present disclosure, when the distance from the user's eyes to the display panel 40 measured by the infrared sensing unit 10 increases, the information perceived by the eyes (e.g., the perceived resolution) is reduced, and the processing control unit 30 lowers the resolution of the display panel 40, thereby reducing the backlight power consumption. When the distance from the user's eyes to the display panel 40 measured by the infrared sensing unit 10 decreases, the information perceived by the eyes (e.g., the perceived resolution) is increased, and the processing control unit 30 raises the resolution of the display panel 40, thereby maintaining the visual effect of the display panel 40.

In accordance with a feature of an embodiment of the present disclosure, when the ambient light brightness measured by the ambient light sensing unit 20 increases, the information perceived by the eyes (e.g., the perceived resolution) is reduced, and the processing control unit 30 lowers the resolution of the display panel 40, thereby reducing the backlight power consumption. When the ambient light brightness measured by the ambient light sensing unit 20 decreases, the information perceived by the eyes (e.g., the perceived resolution) is increased, and the processing control unit 30 raises the resolution of the display panel 40, thereby maintaining the visual effect of the display panel 40.

In accordance with a feature of an embodiment of the present disclosure, when the ambient light brightness measured by the ambient light sensing unit 20 decreases, the information perceived by the eyes is reduced, and the processing control unit 30 raises the brightness of the display panel 40, thereby maintaining the visual effect of the display panel 40. When the ambient light brightness measured by the ambient light sensing unit 20 decreases, the information perceived by the eyes is increased, and the processing control unit 30 lowers the brightness of the display panel 40, thereby reducing the backlight power consumption.

In accordance with a feature of an embodiment of the present disclosure, when the distance from the user's eyes to the display panel 40 measured by the infrared sensing unit 10 increases, the information perceived by the eyes is reduced, and the processing control unit 30 raises the brightness of the display panel 40, thereby maintaining the visual effect of the display panel 40. When the distance from the user's eyes to the display panel measured by the infrared sensing unit 10 decreases, the information perceived by the eyes is increased, and the processing control unit 30 lowers the brightness of the display panel 40, thereby reducing the backlight power consumption.

In accordance with a further feature of an embodiment of the present disclosure, the resolution of the display panel 40 decreases when the measured distance is greater than a threshold, and the resolution of the display panel 40 increases when the measured distance being smaller than another threshold.

In accordance with a further feature of an embodiment of the present disclosure, the brightness of the display panel 40 increases when the measured ambient light brightness is greater than a threshold, and the brightness of the display panel 40 decreases when the measured ambient light brightness is smaller than another threshold.

In accordance with a further feature of an embodiment of the present disclosure, the brightness of the display panel 40 increases when the measured distance is greater than a threshold, and the brightness of the display panel 40 decreases when the measured distance is smaller than another threshold.

In according with a further feature of an embodiment of the present disclosure, the resolution of the display panel is a function of the distance coefficient and the ambient light coefficient:

Resolution=f (distance coefficient, ambient light coefficient) [Equation 1]

The distance coefficient and the ambient light coefficient are independent variables, and the resolution is a dependent variable. The distance coefficient and the ambient light coefficient together affect the resolution. Generally, the larger the distance coefficient and the ambient light coefficient are, the smaller the resolution is. The smaller the distance coefficient and the ambient light coefficient are, the larger the resolution is.

In accordance with to a further feature of an embodiment of the present disclosure, the brightness of the display panel is a function of the distance coefficient and the ambient light coefficient:

Brightness=g (distance coefficient, ambient light coefficient) [Equation 2]

The distance coefficient and the ambient light coefficient are independent variables, and the brightness of the display panel is a dependent variable. The distance coefficient and the ambient light coefficient together affect the brightness of the display panel. Generally, the larger the distance coefficient and the ambient light coefficient are, the greater the brightness is. The smaller the distance coefficient and the ambient light coefficient are, the greater the brightness is.

The present disclosure provides a device 1 having a display panel 40 with low power consumption, including the follows:

An infrared sensing unit 10 includes an infrared sensor, is configured for measuring a distance from a user's eyes to the display panel 40, and transmits the measured distance to a processing control unit 30.

An ambient light sensing unit 20 includes an ambient light sensor, is configured for measuring an ambient light brightness, and transmits the measured ambient light brightness to the processing control unit 30.

The processing control unit 30 includes a processor, and is configured for adjusting a resolution of the display panel 40 based upon the measured distance and the measured ambient light brightness.

In accordance with an embodiment of the disclosure, the infrared sensing unit 10 includes an infrared sensor. In an embodiment, the infrared sensor may be a thermal infrared sensor or a light infrared sensor (or a so-called quantum infrared sensor). The thermal infrared sensor includes a pyroelectric infrared sensor, a thermopile infrared sensor, and a bolometer infrared sensor. The pyroelectric infrared sensor is an infrared sensor which utilizes pyroelectric effect where heat of an object radiates infrared rays irradiating a material to generate electric charges. The thermopile infrared sensor is an infrared sensor which senses a temperature difference to generate a voltage by using a plurality of sets of thermocouples connected in series. The thermistor infrared sensor is an infrared sensor which utilizes a thermistor absorbing infrared rays and causing a change in temperature, thereby causing a change in resistance value.

The light infrared sensor includes a photoelectric effect infrared sensor and a photocell infrared sensor. The photoelectric effect infrared sensor is an infrared sensor which utilizes a photoelectric effect where a photocurrent is generated by a sensing element receiving a photon impact, such as a photodiode, a charge-coupled device (CCD), and a material like CdS or PbS. The photoresistor infrared sensor is an infrared sensor which utilizes a photoresistor which receives a photon impact to cause a change in resistance value.

In an embodiment, the infrared sensor may be an active infrared sensor or a passive infrared sensor. The active infrared sensor actively emits an infrared ray to measure the distance. The passive infrared sensor does not emit infrared rays, but detects infrared rays emitted by an object to measure the distance.

In an embodiment, the infrared sensing unit 10 may further include a chip or circuit to process the measured distance of the infrared sensor, and transmit the processed data to the control unit 30. However, the internal components of the infrared sensing unit 10 are merely examples, and should not limit the scope of the present disclosure.

In accordance with an embodiment of the present disclosure, the ambient light sensing unit 20 includes an ambient light sensor. In an embodiment, the ambient light sensor includes one or more photosensitive elements for acquiring ambient light brightness data, such as a complementary metal-oxide-semiconductor (CMOS) image sensor, a photodiode, a charge coupled device, etc. The ambient light sensor may be implemented with a single light sensitive element, in which case the acquired brightness data are the output of the single light sensitive element. In other embodiments, the ambient light sensor may include a plurality of light sensitive elements, in which case the acquired brightness data is the output of the light sensitive elements.

In an embodiment, the ambient light sensing unit 20 may further include a chip or circuit to process the brightness measured by the ambient light sensor, and transmit the processed data to the control unit 30. However, the internal components of the ambient light sensing unit 20 are merely examples, and should not limit the scope of the present disclosure.

In an embodiment of the present disclosure, the processing control unit 30 includes a central processing unit (CPU) and a memory. The processing control unit 30 can be implemented as a microcomputer, which uses a microprocessor as a central processing unit (CPU), in which multiple functions of the central processing unit are integrated into an integrated circuit (IC) or circuit. The processing control unit 30 may also be implemented as a microcontroller, also known as a single-chip microcomputer, which is a microcomputer in which a central processing unit and a memory are integrated into an integrated circuit chip. The memory is used to store instructions, data, and patient data, and includes volatile memory, such as dynamic random access memory (DRAM) or static random access memory (SRAM), and non-volatile memory includes, such as a read only memory (ROM), a flash memory, a solid state drive, or a magnetic drive. However, the internal components of the process control unit 30 are merely examples, and should not limit the scope of the present disclosure.

In accordance with an embodiment of the present disclosure, the infrared sensing unit 10 is further configured for converting the measured distance into a distance coefficient, and transmitting the distance coefficient to the processing control unit 30, the ambient light sensing unit 20 is further configured for converting the measured ambient light brightness into an ambient light coefficient, and transmitting the ambient light coefficient to the processing control unit 30, and the processing control unit 30 is further configured for adjusting the resolution of the display panel 40 based upon the distance coefficient and the ambient light coefficient.

In accordance with an embodiment of the present disclosure, the processing control unit 30 is configured for converting the measured distance into a distance coefficient, converting the measured ambient light brightness into an ambient light coefficient, and adjusting the resolution of the display panel 40 based upon the distance coefficient and the ambient light coefficient.

For example, the distance coefficient ranges from 0 to 1. When the distance is 40 cm, the distance coefficient is 0.8. When the distance is nearly 10 cm, the distance coefficient is 0.2. However, the distances and the distance coefficients are only examples, and should not limit the scope of the present disclosure.

For example, the ambient light coefficient ranges from 0 to 1. In an outdoor environment, for example, when the illuminance is 30,000 lux, the ambient light coefficient is 0.9. In an indoor environment, for example, when the illuminance is 800 lux, the ambient light coefficient is 0.2. However, the ambient light brightnesses and the ambient light coefficients are only examples, and should not limit the scope of the present disclosure.

In accordance with a feature of an embodiment of the present disclosure, when the distance from the user's eyes to the display panel 40 measured by the infrared sensing unit 10 increases, the information perceived by the eyes (e.g., the perceived resolution) is reduced, and the processing control unit 30 lowers the resolution of the display panel 40, thereby reducing the backlight power consumption. When the distance from the user's eyes to the display panel 40 measured by the infrared sensing unit 10 decreases, the information perceived by the eyes (e.g., the perceived resolution) is increased, and the processing control unit 30 raises the resolution of the display panel 40, thereby maintaining the visual effect of the display panel 40.

In accordance with a feature of an embodiment of the present disclosure, when the ambient light brightness measured by the ambient light sensing unit 20 increases, the information perceived by the eyes (e.g., the perceived resolution) is reduced, and the processing control unit 30 lowers the resolution of the display panel 40, thereby reducing the backlight power consumption. When the ambient light brightness measured by the ambient light sensing unit 20 decreases, the information perceived by the eyes (e.g., the perceived resolution) is increased, and the processing control unit 30 raises the resolution of the display panel 40, thereby maintaining the visual effect of the display panel 40.

In accordance with a feature of an embodiment of the present disclosure, when the ambient light brightness measured by the ambient light sensing unit 20 increases, the information perceived by the eyes is reduced, and the processing control unit 30 raises the brightness of the display panel 40, thereby maintaining the visual effect of the display panel 40. When the ambient light brightness measured by the ambient light sensing unit 20 decreases, the information perceived by the eyes is increased, and the processing control unit 30 lowers the brightness of the display panel 40, thereby reducing the backlight power consumption.

In accordance with a feature of an embodiment of the present disclosure, when the distance from the user's eyes to the display panel 40 measured by the infrared sensing unit 10 increases, the information perceived by the eyes is reduced, and the processing control unit 30 raises the brightness of the display panel 40, thereby maintaining the visual effect of the display panel 40. When the distance from the user's eyes to the display panel 40 measured by the infrared sensing unit 10 decreases, the information perceived by the eyes is increased, and the processing control unit 30 lowers the brightness of the display panel 40, thereby reducing the backlight power consumption.

In accordance with a further feature of an embodiment of the present disclosure, the resolution of the display panel 40 decreases when the measured distance is greater than a threshold, and the resolution of the display panel 40 increases when the measured distance being smaller than another threshold.

In accordance with a further feature of an embodiment of the present disclosure, the brightness of the display panel 40 increases when the measured ambient light brightness is greater than a threshold, and the brightness of the display panel 40 decreases when the measured ambient light brightness is smaller than another threshold.

In accordance with a further feature of an embodiment of the present disclosure, the brightness of the display panel 40 increases when the measured distance is greater than a threshold, and the brightness of the display panel 40 decreases when the measured distance is smaller than another threshold.

In according with a further feature of an embodiment of the present disclosure, the resolution of the display panel 40 is a function of the distance coefficient and the ambient light coefficient:

Resolution=f (distance coefficient, ambient light coefficient) [Equation 1]

The distance coefficient and the ambient light coefficient are independent variables, and the resolution is a dependent variable. The distance coefficient and the ambient light coefficient together affect the resolution. Generally, the larger the distance coefficient and the ambient light coefficient are, the smaller the resolution is. The smaller the distance coefficient and the ambient light coefficient are, the larger the resolution is.

In accordance with to a further feature of an embodiment of the present disclosure, the brightness of the display panel is a function of the distance coefficient and the ambient light coefficient:

Brightness=g (distance coefficient, ambient light coefficient) [Equation 2]

The distance coefficient and the ambient light coefficient are independent variables, and the brightness of the display panel is a dependent variable. The distance coefficient and the ambient light coefficient together affect the brightness of the display panel. Generally, the larger the distance coefficient and the ambient light coefficient are, the greater the brightness is. The smaller the distance coefficient and the ambient light coefficient are, the greater the brightness is.

In the method for reducing power consumption of the display panel, and the device having the display panel with low power consumption in the present disclosure, the infrared sensing unit measures the distance from the user's eyes to the display panel. When the measured distance increases, the information perceived by the eyes (e.g., the perceived resolution) is reduced, and the processing control unit lowers the resolution of the display panel. When the measured distance decreases, the information perceived by the eyes (e.g., the perceived resolution) is increased, and the processing control unit raises the resolution of the display panel, thereby ensuring the visual effect of the display panel while reducing backlight power consumption.

In summary, although the preferable embodiments of the present disclosure have been disclosed above, the embodiments are not intended to limit the present disclosure. A person of ordinary skill in the art, without departing from the spirit and scope of the present disclosure, can make various modifications and variations. Therefore, the scope of the disclosure is defined in the claims.

What is claimed is:

1. A method for reducing power consumption of a display panel, comprising:
a step 100 of measuring a distance from a user's eyes to the display panel by an infrared sensing unit, and measuring an ambient light brightness by an ambient light sensing unit;
a step 200 of transmitting the measured distance to a processing control unit by the infrared sensing unit, and transmitting the measured ambient light brightness to the processing control unit by the ambient light sensing unit; and
a step 300 of adjusting a resolution of the display panel by the processing control unit based upon the measured distance and the measured ambient light brightness.

2. The method as claimed in claim 1, further comprising:
a step 400 of adjusting a brightness of the display panel by the processing control unit based upon the measured distance and the measured ambient light brightness.

3. The method as claimed in claim 1, wherein the resolution of the display panel decreases when the measured distance increases, and the resolution of the display panel increases when the measured distance decreases.

4. The method as claimed in claim 1, wherein the resolution of the display panel decreases when the measured ambient light brightness increases, and the resolution of the display panel increases when the measured ambient light brightness decreases.

5. The method as claimed claim 2, wherein the brightness of the display panel increases when the measured ambient light brightness increases, and the brightness of the display panel decreases when the measured ambient light brightness decreases.

6. The method as claimed in claim 2, wherein the brightness of the display panel increases when the measured distance increases, and the brightness of the display panel decreases when the measured distance decreases.

7. The method as claimed in claim 1, wherein the step 200 comprises:
a step of converting the measured distance into a distance coefficient and transmitting the distance coefficient to the processing control unit by the infrared sensing unit, and a step of converting the measured ambient light brightness into an ambient light coefficient and transmitting the ambient light coefficient to the processing control unit by the ambient light sensing unit; and the step 300 comprises:
a step of adjusting the resolution of the display panel by the processing control unit based upon the distance coefficient and the ambient light coefficient.

8. The method as claimed in claim 1, wherein the step 300 comprises:
a step of converting the measured distance into a distance coefficient by the processing control unit, a step of converting the measured ambient light brightness into an ambient light coefficient by the processing control unit, and a step of adjusting the resolution of the display panel by the processing control unit based upon the distance coefficient and the ambient light coefficient.

9. A device having a display panel with low power consumption, comprising:
an infrared sensing unit including an infrared sensor, configured for measuring a distance from a user's eyes to the display panel, and transmitting the measured distance to a processing control unit;
an ambient light sensing unit including an ambient light sensor, configured for measuring an ambient light brightness, and transmitting the measured ambient light brightness to the processing control unit; and
the processing control unit including a processor, and configured for adjusting a resolution of the display panel based upon the measured distance and the measured ambient light brightness.

10. The device having a display panel with low power consumption as claimed in claim 9, wherein the processing control unit configured for adjusting a brightness of the display panel based upon the measured distance and the measured ambient light brightness.

11. The device having a display panel with low power consumption as claimed in claim 9, wherein the processing control unit is configured for lowering the resolution of the display panel in response to the measured distance being greater than a threshold, and the processing control unit is configured for raising the resolution of the display panel in response to the measured distance being smaller than another threshold.

12. The device having a display panel with low power consumption as claimed in claim 9, wherein the processing control unit is configured for lowering the resolution of the display panel in response to the measured ambient light brightness being greater than a threshold, and the processing control unit is configured for raising the resolution of the display panel in response to the measured ambient light brightness being smaller than another threshold.

13. The device having a display panel with low power consumption as claimed in claim 10, wherein the processing control unit is configured for raising the brightness of the display panel in response to the measured ambient light brightness being greater than a threshold, and the processing control unit is configured for lowing the brightness of the display panel in response to the measured ambient light brightness being smaller than another threshold.

14. The device having a display panel with low power consumption as claimed in claim 10, wherein the processing control unit is configured for raising the brightness of the display panel in response to the measured distance being greater than a threshold, and the processing control unit is configured for lowing the brightness of the display panel in response to the measured distance being smaller than another threshold.

15. The device having a display panel with low power consumption as claimed in claim 9, wherein
the infrared sensing unit is further configured for converting the measured distance into a distance coefficient, and transmitting the distance coefficient to the processing control unit, the ambient light sensing unit is further configured for converting the measured ambient light brightness into an ambient light coefficient, and transmitting the ambient light coefficient to the processing control unit; and
the processing control unit is further configured for adjusting the resolution of the display panel based upon the distance coefficient and the ambient light coefficient.

16. The device having a display panel with low power consumption as claimed in claim 9, wherein
the processing control unit is configured for converting the measured distance into a distance coefficient, converting the measured ambient light brightness into an ambient light coefficient, and adjusting the resolution of the display panel based upon the distance coefficient and the ambient light coefficient.
